(19) United States
(12) Patent Application Publication
(10) Pub. No.: US 2026/0087701 A1
(43) Pub. Date: Mar. 26, 2026

(54) VIDEO EDITING USING DIFFUSION MODELS

(71) Applicant: Google LLC, Mountain View, CA (US)

(72) Inventors: Yaniv Leviathan, New York, NY (US); Eyal Molad, Holon (IL); Eliahu Moshe Horwitz, Jerusalem (IL); Daniel Walevski, Tel Aviv (IL); Alexander Rav Acha, Rehovot (IL); Yossi Matias, Tel Aviv (IL); Yedid Hoshen, Jerusalem (IL); Yael Pritch Knaan, Pritch Knaan (IL)

(21) Appl. No.: 19/286,151

(22) Filed: Jul. 30, 2025

Related U.S. Application Data
(63) Continuation of application No. PCT/US2024/013791, filed on Jan. 31, 2024.
(60) Provisional application No. 63/442,343, filed on Jan. 31, 2023.

(51) Int. Cl. G06T 11/60; G06N 3/0985

(52) U.S. Cl. CPC G06T 11/60; G06N 3/0985; G06T 2211/441

(57) ABSTRACT

Methods, systems, and apparatus, including computer programs encoded on computer storage media, for generating an output video. One of the methods include: obtaining an input video; obtaining input text that includes a description of an output video; generating, based at least on applying downsampling to the input video, a degraded version of the input video; and generating the output video based on the description in the input text by updating the degraded version of the input video by using a video diffusion model across a plurality of reverse diffusion steps.

### CROSS-REFERENCE TO RELATED APPLICATIONS

This application is a continuation of PCT Application No. PCT/US2024/013791, filed on Jan. 31, 2024, which claims priority to U.S. Provisional Patent Application No. 63/442,343, filed on Jan. 31, 2023, and the disclosure of these applications are incorporated herein by reference in their entirety.

### BACKGROUND

This specification relates to video processing using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes how a conditional video generation system implemented as computer programs on one or more computers in one or more locations can generate an output video from a system input. The conditional video generation system is a system that facilitates text-based appearance or motion editing of objects depicted in input videos. A video includes multiple video frames that each include multiple pixels. Each pixel in each video frame has one or more intensity values.

In general, one innovative aspect of the subject matter described in this specification can be embodied in a method of generating an output video, the method comprising: obtaining an input video; obtaining input text that includes a description of an output video; generating, based at least on applying downsampling to the input video, a degraded version of the input video; and generating the output video based on the description in the input text by updating the degraded version of the input video, wherein the updating comprises, at each of a plurality of steps: processing, by a diffusion model, a diffusion model input comprising (i) a current intermediate representation of the output video and (ii) the input text to generate a noise output for the step; and using the noise output to de-noise the current intermediate representation of the output video to generate an updated intermediate representation of the output video for the step.

In some examples, the conditional video generation system comprises a video editing system.

In some cases, the system input includes an input video and input text. The input video may include a temporal sequence of video frames that show any of a variety of types of objects, including landmarks, landscape or location features, vehicles, tools, food, clothing, devices, animals, to name just a few examples. The input text may include a text prompt that describes the output video, e.g., that describes one or more desired properties or characteristics that an object shown in the output video should have.

For example, the text prompt may define or otherwise specify that the output video should show an extra object that was not shown in the input video (or vice versa, namely the output video should omit an existing object that was shown in the input video). As another example, the text prompt may define or otherwise specify that an object shown in the output video should have a different visual appearance than that of the object as shown in the input video. As another example, the text prompt may define or otherwise specify that an object shown in the output video should have a different motion than that of the object as shown in the input video, i.e., the input and output videos each show the object having a different continual motion starting from a beginning frame to an end frame of the video.

In these cases, the system processes the system input and generates an output video from the input video under the guidance of the input text. The output video generated by the system thus includes a sequence of video frames that not only reflects the input text but also ensures temporal consistency between the input video and the generated frames of the output video.

In other cases, the system input includes an input image, or a single video frame, and the input text prompt that describes the output video. The input image may similarly show any of the variety of types of objects mentioned above. In these other cases, the system additionally employs a video synthesis process where the system generates a synthetic video having multiple frames from the input image, e.g., by applying duplication, replication, perspective transformation, instead of or in addition to other image process operations to the input image. The synthetic video is used as the input video which will then be processed by the system to generate the output video.

The system can obtain the system input in any of a variety of ways. For example, the system can receive the input video and/or the input text as an upload from a remote user of the system over a data communication network, e.g., using an application programming interface (API) made available by the system. As another example, the system can receive an input from a user specifying which video data that is already maintained by the system or another system that is accessible by the system should be used as the input video from which the output video is to be generated.

The video editing system generates the output video conditioned on the system input by using a video diffusion model. Some implementations of the system can use a video diffusion model which, rather than predicting one frame after another to output the video, jointly models entire videos, or blocks of frames to improve temporal coherence between the input video and the generated frames.

Prior to using the video diffusion model to generate output videos, the video editing system fine-tunes the model, i.e., determines updates to the pre-trained parameter values of the video diffusion model, with respect to the input video based on optimizing a mixed fine-tuning objective to improve the quality of motion edits to the input video. In particular, by holding the pre-trained parameter values of the temporal attention layers in the model fixed, e.g., through masking, while allowing the pre-trained parameter values of the spatial attention layers in the model to be updated, the video editing system fine-tunes the video diffusion model to reconstruct individual frames of the input video while discarding information about the temporal order of these frames.

Generating the output video by using a video diffusion model typically involves performing a sequence of multiple reverse diffusion steps to iteratively update, i.e., de-noise, an intermediate, i.e., noisy, representation of the video in accordance with a noise term computed by the model as of the step. Instead of initializing such an intermediate representation by determining intensity values for each pixel in each video frame by sampling from a noise distribution, e.g., a Gaussian noise distribution, however, the described video editing system initializes the intermediate representation by applying downsampling and, in some cases, adding noise, to the input video to generate a degraded version of the input video. In this way, the first reverse diffusion step in the sequence is performed on the degraded version of the input videos which, despite its low resolution, still contains the spatiotemporal information from the original, input video that facilitates generation of higher quality output videos.

The subject matter described in this specification can be implemented in particular embodiments so as to realize one or more of the following advantages.

The techniques described in this specification extend the usage of a video diffusion model, which is advantageously configured as a diffusion model that jointly models entire videos, or blocks of frames, to text-based video editing, i.e., to being operable to process an input video and a text prompt to generate an output video which reflects the text prompt from the input video. By fine-tuning the video diffusion model to optimize a mixed fine-tuning loss function and subsequently configuring the fine-tuned model to generate the output video by performing multiple diffusion steps that begin from a degraded version of an input video, e.g., rather than simply from random noise, the described techniques ensure preservation of high-resolution details such as fine textures or object identity in the output video, and combine the low-resolution spatiotemporal information from the input video with the synthesized, high-resolution information that is generated by using the model during inference to improve the alignment of the content in output video with the text prompt.

The described techniques enable customized modification to either the motion or the appearance, and in particular, both the motion and the appearance of an object that is depicted in an input video. Because the described techniques facilitate generation of smooth visual modifications that align with the temporal information in the input video, the output video is a high quality video that shows the object having the desired motion and/or appearance with temporal consistency over multiple video frames. The described techniques enable new applications that were previously difficult or costly to achieve in the field of computer vision, including animation of the objects/background in a static image, and creation of dynamic camera motion, to name just a few examples.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is a diagram that illustrates an example architecture for fine-tuning a video diffusion model.

FIG. 1B is a diagram that illustrates an example architecture for performing inference using a fine-tuned video diffusion model.

FIG. 2 is a flow diagram of an example process for generating an output video.

FIG. 3 is a flow diagram of sub-steps of one of the steps of the process of FIG. 2.

Like reference numbers and designations in the various drawings indicate like elements.

### DETAILED DESCRIPTION

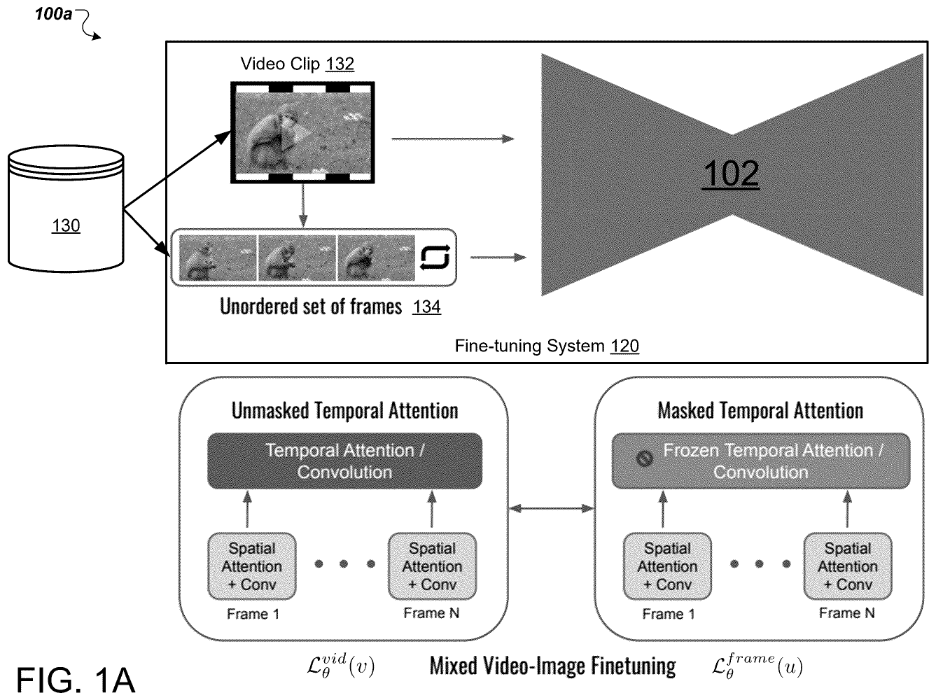

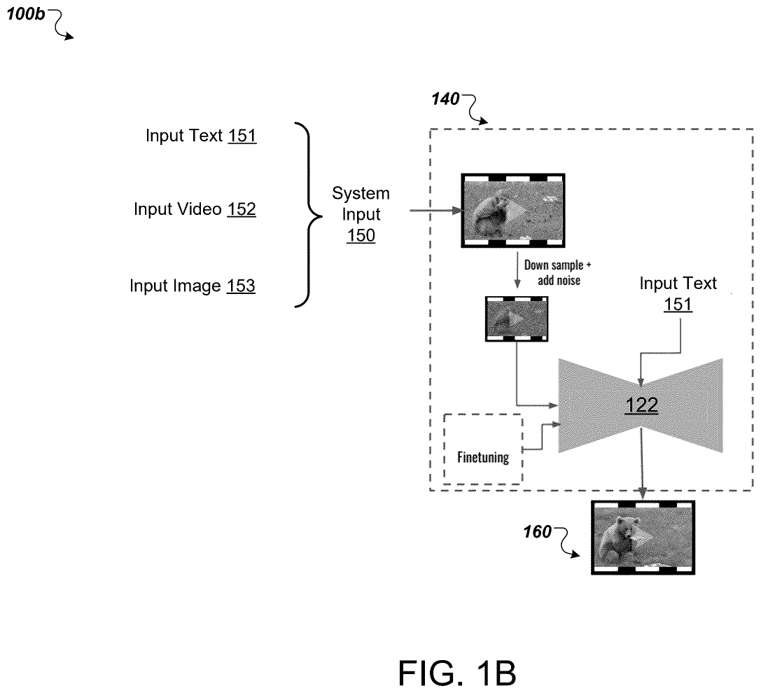

FIGS. 1A and 1B respectively illustrate example architectures for fine-tuning and performing inference using a video diffusion model. In particular, FIG. 1A is a diagram that illustrates an example architecture 100a for fine-tuning a video diffusion model 102. The architecture 100a includes a fine-tuning system 120. The components of the fine-tuning system 120 can be implemented by a computing system comprising one or more computers that coordinate to fine-tune the video diffusion model 102.

The video diffusion model 102 can be any appropriate diffusion neural network that has been pre-trained, e.g., by the fine-tuning system 120 or another training system, to generate an output video by executing a reverse diffusion process over multiple reverse diffusion steps.

In some cases, the video diffusion model 102 can include a sequence (or “cascade”) of a low resolution video diffusion model and a high resolution video diffusion model, which is configured to generate a high resolution video (where each video frame has a relatively higher resolution) as the output video conditioned on a low resolution video (where each video frame has a relatively lower resolution) generated by the lower resolution video diffusion model. By making use of a sequence of video diffusion models, the video diffusion model 102 can iteratively up-scale the resolution of the video, ensuring that a high-resolution video can be generated without requiring a single model to generate the video at the desired output resolution directly.

At each reverse diffusion step, the video diffusion model 102 is configured to process a diffusion model input that includes a current intermediate (e.g., noisy) representation of the output video in accordance with the pre-trained values of the parameters to generate a noise output and use the noise output to update (e.g., de-noise) the current intermediate representation to generate an updated (e.g., de-noised) intermediate representation. For example, the noise output can be an estimate of the noise that needs to be, e.g., added to the video being generated by the system 100, to generate the current intermediate representation of the video.

In some cases, the computing system can be a distributed computing system comprising a plurality of computers. However, in other cases, because the fine-tuning process utilize a relatively small number of images, i.e., compared to the massive number of images required during the pre-training process, the computing system can include much less computationally expensive hardware, e.g., a desktop computer, laptop computer, or mobile computing device.

A video (also referred to as a “video clip” below) includes multiple video frames that each include multiple pixels. Each pixel in each video frame has one or more intensity values. In some cases, the video diffusion model 102 is configured to generate the video by predicting one frame after another. For example, the video diffusion model 102 can generate a video that has an indefinite length, i.e., includes a varying number of frames, by predicting a next frame of a video autoregressively. In other cases, rather than predict each individual frame, the video diffusion model 102 is configured to jointly model the entire video, or blocks of frames. In these other cases, temporal coherence between the generated frames, perceptual quality of the generated frames, or both might be improved.

For example, the video diffusion model 102 can have been trained on a set of training images based on optimizing a pre-training objective function defined as:

$${ℒ}_{θ} ( v ) = {𝔼}_{ϵ ∼ N ( 0 , I ) , s ∈ 𝒰 ( 0 , 1 )} {‖ {D}_{θ} ( {z}_{s} , s , t , c ) - v ‖}^{2} \qquad ( 1 )$$

In Equation (1), D_{θ} represents the video diffusion model 102 that has a set of parameters θ and that is configured to receive a diffusion model input that includes (i) a noisy representation zₛ of the ground truth video v, (ii) data identifying a time step s, (iii) a text prompt t, and (iv) a conditioning video c (e.g., a lower resolution version of the ground truth video v that is being predicted by the video diffusion model 102), and to process the diffusion model input in accordance with the set of parameters θ to generate a noise output that can be used to generate an updated (e.g., de-noised) intermediate representation of the ground truth video v. ∈ is noise that is sampled from a noise distribution (e.g., a Gaussian distribution N(0, I)). The noisy representation zₛ of the ground truth video can be given by zₛ=γₛv+σₛ∈, where

$${γ}_{s} = \sqrt{1 - {σ}_{s}^{2}}$$

and σₛ is the noise level at time step s.

Examples architectures of video diffusion models as well as techniques for training such models are described in more detail in Jonathan Ho, et al., Imagen video: High definition video generation with diffusion models. arXiv preprint arXiv: 2210.02303 (2022), Jonathan Ho, et al., Video diffusion models. arXiv preprint arXiv: 2204.03458, 2022, Lijun Yu, et al., Magvit: Masked generative video transformer. arXiv preprint arXiv: 2212.05199, and Uriel Singer, et al., Make-a-video: Text-to-video generation without text-video data. arXiv preprint arXiv: 2209.14792 (2022), the entire contents of which are hereby incorporated by reference herein in their entirety.

The fine-tuning system 120 obtains a fine-tuning dataset 130 and uses the fine-tuning dataset 130 to fine-tune the pre-trained video diffusion model 102, i.e., to update the pre-trained values of the parameter of the video diffusion model 102. The fine-tuning dataset 130 includes a plurality of video clips 132, where each video clip 132 includes a plurality of consecutive video frames. The fine-tuning dataset 130 also includes a plurality of unordered video frames 134. Each video frame 134 can be an individual image.

In some cases, the plurality of video clips 132 each depict a particular subject instance of an object class (rather than varying subject instances of the object class). Likewise, in some cases, the plurality of unordered video frames 134 each depict a particular subject instance of an object class (rather than varying subject instances of the object class). Generally, there might be multiple subject instances that belong to a common object class. For any object class, each subject instance belonging to the object class may have a set of appearance characteristics that visually distinguish it from other subject instances that also belong to the same object class. In other words, different subject instances might appear differently than each other, although they all belong to the same object class.

The fine-tuning system 120 can obtain the fine-tuning dataset 130 in any of a variety of ways. For example, the system can receive the plurality of video clips 132 as an upload from a remote user of the system over a data communication network, e.g., using an application programming interface (API) made available by the system, and randomly shuffle the plurality of consecutive video frames included in each of one or more video clips to generate the plurality of unordered video frames 134. As another example, the system can receive an input from a user specifying which video data that is already maintained by the system or another system that is accessible by the system should be used as the plurality of video clips 132, and randomly shuffle the plurality of consecutive video frames included in each of one or more video clips to generate the plurality of unordered video frames 134.

In particular, the fine-tuning system 120 fine-tunes the video diffusion model 102 over multiple fine-tuning steps by optimizing a mixed fine-tuning objective based on the video clips 132 and the individual video frames 134 sampled from the fine-tuning dataset 130. The mixed fine-tuning objective function includes a video clip reconstruction loss term that evaluates, for each video clip v sampled from the plurality of video clips 132 included in the fine-tuning dataset 130, a difference between (i) the video clip v and (ii) a reconstructed representation of the video clip generated by using the video diffusion model 102. In other words, the video clip reconstruction loss term trains the video diffusion model 102 to reconstruct an entire video clip that includes multiple consecutive video frames.

For example, the video clip reconstruction loss term can be defined as:

$${ℒ}_{θ}^{vid} ( v ) = {𝔼}_{ϵ ∼ N ( 0 , I ) , s ∈ 𝒰 ( 0 , 1 )} {‖ {D}_{{θ}^{′}} ( {z}_{s} , s , t * , c ) - v ‖}^{2} \qquad ( 2 )$$

Equation (2) differs from Equation (1) mentioned above at least in that, in some cases, during the fine-tuning process, the text prompt included in the diffusion model input to the video diffusion model 102 includes a unique identifier. That is, t* represents the text prompt when it includes a unique identifier, and t represents the text prompt when it does not include such a unique identifier. In some other cases where the text prompt does not include the unique identifier, t* becomes t in Equation (2).

The unique identifier identifies a particular subject instance depicted in the video clip. The unique identifier can be represented as a string of characters in a given text encoding format, e.g., a Unicode format, an ASCII format, or another text encoding format.

Generally, the unique identifiers for different subject instances will be different. That is, a first unique identifier for a first subject instance may include different tokens than a second unique identifier for a second subject instance. For example, the first subject instance could be a vehicle, and the second subject instance could be an animal. As another example, the first subject instance could be a vehicle that has a first shape/size/color, and the second subject instance could be a vehicle that has a second shape/size/color.

To generate such a unique identifier, the fine-tuning system 120 can for example use the techniques described in Nataniel Ruiz, et al. Dreambooth: Fine tuning text-to-image diffusion models for subject-driven generation. Proceedings of the IEEE/CVF Conference on Computer Vision and Pattern Recognition. 2023, the content of which is incorporated by reference into this specification in its entirety.

The mixed fine-tuning objective function also includes an individual frame reconstruction loss term that evaluates, for each individual video frame u sampled from the plurality of unordered video frames 134 included in the fine-tuning dataset 130, a difference between (i) the video frame u and (ii) a reconstructed representation of the video frame generated by using the video diffusion model 102. In other words, the individual frame reconstruction loss term trains the video diffusion model 102 to reconstruct individual video frames (rather than entire video clips).

For example, the individual frame reconstruction loss term can be defined as:

$${ℒ}_{θ}^{frame} ( u ) = {𝔼}_{ϵ ∼ N ( 0 , I ) , s ∈ 𝒰 ( 0 , 1 )} {‖ {D}_{{θ}^{′}}^{a} ( {z}_{s} , s , t * , c ) - u ‖}^{2} \qquad ( 3 )$$

In Equation (3), u represents an individual video frame sampled from the plurality of unordered video frames 134 included in the fine-tuning dataset 130. For example, the individual video frame u can be any frame included in one of the plurality of video clips v included in the fine-tuning dataset 130.

$${D}_{θ}^{a}$$

represents the video diffusion model 102 that, in some cases, has a modified architecture where its temporal attention layers are masked (as will be explained below). In some other cases where the architecture is not modified,

$${D}_{θ}^{a}$$

becomes D_{θ} in Equation (3).

For example, at each fine-tuning step, the fine-tuning system 120 can update the current (e.g., pre-trained) values of the parameters θ′ of the video diffusion model 102 to determine updated (e.g., fine-tuned) values of the parameters θ based optimizing a mixed fine-tuning objective that includes both the video clip reconstruction loss term and the individual frame reconstruction loss term according to:

$$θ = arg {min}_{{θ}^{′}} {αℒ}_{{θ}^{′}}^{vid} ( v ) + ( 1 - α ) {ℒ}_{{θ}^{′}}^{frame} ( u ) \qquad ( 4 )$$

In Equation (4), α is a weighting between the video clip reconstruction loss term and the individual frame reconstruction loss term. α can correspond to a tunable hyperparameter of the fine-tuning system 120.

During the fine-tuning, the fine-tuning system 120 can incorporate any number of techniques to improve the effectiveness, the efficiency, or both of the fine-tuning process. For example, the fine-tuning system 120 can use a small number of finetuning steps (FTₛₜₑₚₛ), a low learning rate lr (e.g., approximately 6·10⁻⁶, or lower), or both in combination with a specific choice of the weighting value to reduce overfitting. Some illustrative combinations of fine-tuning steps and weighting values are given below:

$$α = 1. ( video only finetuning ) , {FT}_{steps} = 64$$

$$α = 0.35 ( mixed video / video - frame finetuning ) ,$$

$${FT}_{steps} ∈ [ 200 , 300 ]$$

$$α = 0 ( video - frame only finetuning , {FT}_{steps} ∈ [ 50 , 150 ]$$

Moreover, depending on the configuration of the video diffusion model 102, e.g., whether it has a Transformer-based architecture or a convolutional architecture, or whether it generates one video frame after another autoregressively or jointly outputs the entire video, the fine-tuning system 120 can incorporate different techniques when fine-tuning the video diffusion model 102.

In some cases, the architecture of the pre-trained video diffusion model 102 remains unchanged during the fine-tuning. In other cases, however, the architecture of the pre-trained video diffusion model 102 is modified during the fine-tuning, e.g., by adding one or more additional layers either in place of or in addition to the existing layers of the pre-trained video diffusion model 102.

In some cases, all of the parameters of the video diffusion model 102 are adjusted during the fine-tuning. In other cases, only some of the parameters of the video diffusion model 102 are updated, while others of the parameters of the video diffusion model 102 are held fixed to their pre-trained values. As a particular example of this, the parameters of some layers of the video diffusion model 102 are held fixed and only the parameters of some other layers of the video diffusion model 102 are updated.

As a particular example of this, the video diffusion model 102 can have a Transformer-based architecture that includes one or more temporal attention layers, one or more one or more spatial attention layers, and one or more convolutional layers. A temporal attention layer is a layer that includes an attention mechanism, e.g., a query-key-value (QKV) attention mechanism, and that attends over the plurality of video frames in a video when generating a corresponding temporal attention layer output from a temporal attention layer input. A spatial attention layers is a layer that includes an attention mechanism, and that attends over a plurality of pixels in a video frame when generating a corresponding spatial attention layer output from a spatial attention layer input. A convolutional layer is a layer that applies a convolution filter across a plurality of pixels in a video frame when generating a corresponding convolutional layer output from a convolutional layer input.

In this example, the fine-tuning system 120 can adjust the pre-trained parameter values of the one or more spatial attention layers while holding the pre-trained parameter values of the one or more temporal attention layers and the one or more convolution layers fixed when fine-tuning the video diffusion model 102 based on optimizing the individual frame reconstruction loss term. This can for example be done by inserting a mask before each temporal attention layer and each convolution layer included in the video diffusion model 102.

FIG. 1A thus illustrates that, when fine-tuning the video diffusion model 102 based on optimizing the video clip reconstruction loss term by processing the video clips v sampled from the plurality of video clips 132 included in the fine-tuning dataset 130, the video diffusion model 102 has its original, unmodified architecture (where the temporal attention layer and convolution layers are unmasked). Alternatively, when fine-tuning the video diffusion model 102 based on optimizing the individual frame reconstruction loss term by processing the individual video frames u sampled from the plurality of unordered video frames 134 included in the fine-tuning dataset 130, the video diffusion model 102 has a modified architecture (where the temporal attention layer and convolution layers are masked).

In particular, by holding the pre-trained parameter values of the temporal attention layers and convolution layers in the video diffusion model 102 fixed, e.g., through masking, while allowing the pre-trained parameter values of the spatial attention layers in the video diffusion model 102 to be updated, the fine-tuning system 120 fine-tunes the video diffusion model 102 to reconstruct individual frames sampled from the fine-tuning dataset 130, while discarding information about the temporal order of these frames.

Once the fine-tuning is complete, e.g., after a predetermined number of fine-tuning steps have been performed, the fine-tuning system 120 can provide data specifying the fine-tuned video diffusion model 102, i.e., data specifying the fine-tuned parameter values and, in some cases, the architecture of the video diffusion model 102, for deployment for performing inference, e.g., for conditional video generation or video content editing, on another system. Alternatively or in addition, the fine-tuning system 120 can deploy the fine-tuned video diffusion model 102 and use the video diffusion model to generate new videos in response to user requests.

FIG. 1B is a diagram that illustrates an example architecture 100b for performing inference using a fine-tuned video diffusion model 122. The architecture 100b includes a conditional video generation system 140 implemented by a computing system comprising one or more computers that includes a fine-tuned video diffusion model 122 whose parameters have been adjusted according to the fine-tuning process.

The conditional video generation system 140 can use the fine-tuned video diffusion model 122 to generate an output video 160 conditioned on a system input 150 provided by a user of the system, e.g., through a client device.

In some cases, the system input 150 includes input text 151. The input text 151 may include a text prompt, e.g., in a natural language, that describes the output video 160, e.g., that describes one or more desired properties or characteristics that an object shown in the output video should have.

In some of these cases, the text prompt may include a unique identifier that identifies a particular subject instance, e.g., one of the subject instances depicted in the plurality of video clips 132 and/or the plurality of unordered video frames 134 included in the fine-tuning dataset 130 used in the fine-tuning process. As mentioned above, the unique identifier can be represented as a string of characters in a given text encoding format, e.g., a Unicode format, an ASCII format, or another text encoding format.

In some cases, the system input 150 includes an input video 152. The input video 152 may include a temporal sequence of video frames that show any of a variety of types of objects, including landmarks, landscape or location features, vehicles, tools, food, clothing, devices, animals, to name just a few examples.

In some cases, the system input 150 includes an input image 153, or a single video frame. The input image 153 may similarly show any of the variety of types of objects mentioned above.

In some cases, the system input 150 includes two or more of the data items mentioned above. For example, the system input 150 includes both the input text 151 and the input video 152, where the input text 151 specifies a desired edit or modification that needs to be made to the input video 152. Specifically, the input text 151 may include a text prompt that defines or otherwise specifies that the output video 160 should show an extra object that was not shown in the input video 152 (or vice versa, namely the output video 160 should omit an existing object that was shown in the input video 152). Additionally or alternatively, the input text 151 may include a text prompt that defines or otherwise specifies that the output video 160 should show a new object in place of an existing object shown in the input video 152. Additionally or alternatively, the input text 151 may include a text prompt that defines or otherwise specifies that an object shown in the output video 160 should have a different visual appearance than that of the object as shown in the input video 152. Additionally or alternatively, the input text 151 may include a text prompt that defines or otherwise specifies that an object shown in the output video 160 should have a different motion than that of the object as shown in the input video 152, i.e., the input and output videos each show the object having a different continual motion starting from a beginning frame to an end frame of the video.

As another example, the system input 150 includes both the input text 151 and the input image 153, where the input text 151 specifies how the output video 160 should be generated based on the input image 153, e.g., based on one or more objects depicted in the input image 153. For example, the input text 151 may specify that the output video 160 should depict the same subject instance depicted in the input image 153, e.g., in addition to other background objects, that has a specific motion, and so on.

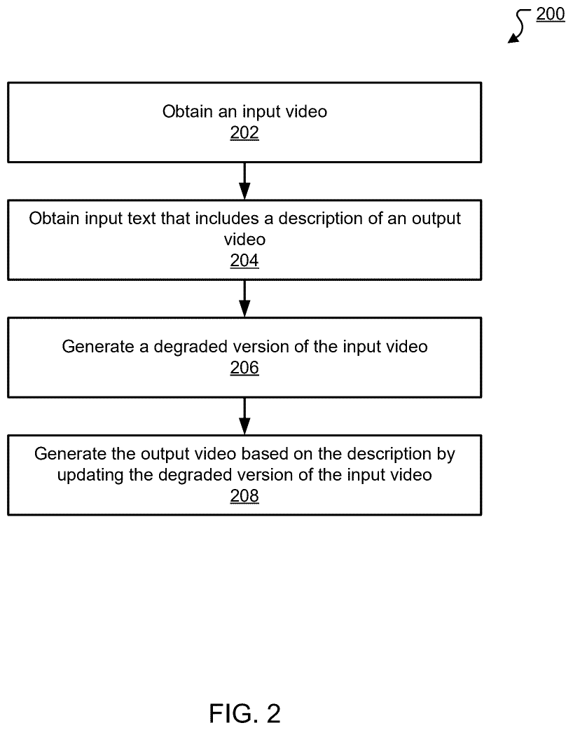

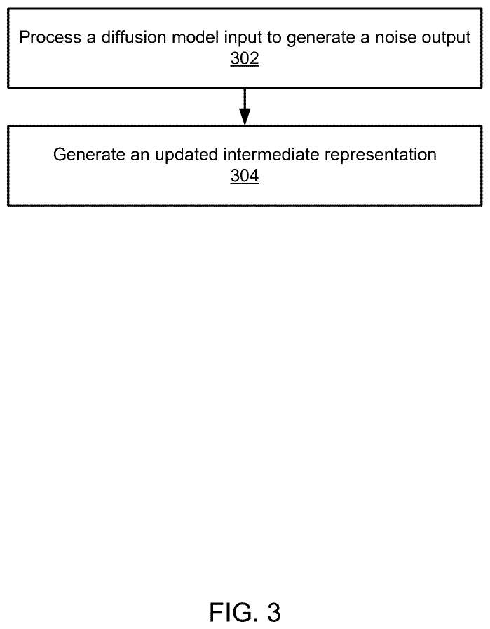

After obtaining the system input 150, the conditional video generation system 150 can then process the system input 150 and generate the output video 160 by using the fine-tuned video diffusion model 122 conditioned on the system input 150 by performing a reverse diffusion process across multiple reverse diffusion steps. Generating the output video 160 by using the fine-tuned video diffusion model 122 will be described in more detail below with reference to FIGS. 2-3. The conditional video generation system 150 can then provide the output video 160 for presentation to the user that provided the system input 150, e.g., on a client device.

The output video 160 includes a sequence of video frames. Depending on what is included in the system 150, the video frames included in the output video 160 can depict any of a variety of content.

For example, when the system input 150 includes both an input video 152 and input text 151 that specifies a desired edit or modification that needs to be made to the input video 152, the output video 160 can be an edited or modified version of the input video 152 that has the desired edit or modification, e.g., shows an extra object, omits an existing object, replaces an existing object with a new object, shows an object with a different visual appearance, shows an object with a different motion, and so on. As a particular example, the output video 160 and the input video 152 both depict the same subject instance, however, a motion, a visual appearance, or both of that subject instance are different.

In particular, in this example, by virtue of the fine-tuning process, the output video 160 includes a sequence of video frames that not only reflects the desired edit or modification specified by the input text 151, but also ensures temporal consistency between the frames included in the input video 152 and the frames included in the output video 160.

As another example, when the system input 150 includes both an input image 153 and input text 151 that specifies how the output video 160 should be generated based on the input image 153, the output video 160 can reflect both the input text 151 and the input image 153. For example, the output video 160 can depict the same subject instance depicted in the input image 153, e.g., in addition to other background objects specified by the input text 151, that has a specific motion specified by the input text 151, and so on.

As yet another example, when the system input 150 includes input text 151 that in turn includes a unique identifier that identifies a particular subject instance of an object class, the output video 160 can depict the particular subject instance (rather than varying subject instances of the object class), e.g., in addition to other background objects also specified by the input text 151, that has a specific motion also specified by the input text 151, and so on.

FIG. 2 is a flow diagram of an example process 200 for generating an output video. For convenience, the process 200 will be described as being performed by a system of one or more computers located in one or more locations. For example, a conditional video generation system, e.g., the conditional video generation system 150 of FIG. 1B, appropriately programmed, can perform the process 200.

The system obtains an input video that includes a plurality of video frames (step 202). In some cases, the system can receive the input video, e.g., as an upload, from a client device. In these cases, the input video may include a temporal sequence of video frames, i.e., where the plurality of video frames are arranged in a temporal order. In other cases, the system can receive an input image from a client device, and then execute a video synthesis process to generate a synthetic video that has a plurality of frames from the input image. The synthetic video will then be used as the input video.

Specifically, executing the video synthesis process can involve applying any of a variety of conventional image processing operations to the input image to generate respective output images for inclusion as the frames of the synthetic video. For example, the system can apply a replication operation to the input image to generate one or more replicated input images, and include the one or more replicated input images as the frames of the synthetic video. As another example, the system can apply a perspective transformation to the input image to generate one or more transformed input images, and include the one or more transformed input images as the frames of the synthetic video. Other image processing operations can also be used.

The system obtains input text (step 204). For example, the input text can be provided by the same client device that also provided the input video (or the same client device that also provided the input video from which the input video is generated). The input text may include a description of the output video, e.g., that describes one or more desired properties or characteristics that an object shown in the output video should have. Additionally or alternatively, the input text may specify a desired edit or modification that needs to be made to the input video.

The system initializes the output video, i.e., generates an initial intermediate representation of the output video, based on the input video (step 206). In particular, the system does this by applying downsampling the input video to generate a downsampled version of the input video, where the frames included in the downsampled input video will have a lower resolution than the frames included in the input video; and then adding noise, e.g., Gaussian noise with a predetermined variance, to the downsampled input video to generate a degraded version of the input video. The degraded version of the input video is then used as the initial intermediate representation of the output video.

By doing so, the system ensures that the first reverse diffusion step in the reverse diffusion process is performed on the degraded version of the input video which, despite its low resolution, still contains the spatiotemporal information from the original, input video that facilitates generation of higher quality output videos.

This is in contrast to some conventional reverse diffusion processes where such an initial intermediate representation is generated from pure noise, for example by determining intensity values for each pixel in each frame included in the output video by sampling from a noise distribution, e.g., a Gaussian noise distribution.

The system generates the output video based on the description in the input text by updating the initial intermediate representation of the output video (step 208). The output video that is generated by the system will include a temporal sequence of video frames, i.e., includes a plurality of video frames arranged in a temporal order. For example, the output video can be an edited or modified version of the input video that has the desired edit or modification, e.g., shows an extra object, omits an existing object, replaces an existing object with a new object, shows an object with a different visual appearance, shows an object with a different motion, and so on.

Generating the output video is described in more detail below with reference to FIG. 3, which shows sub-steps 302-304 of step 208. The system can generate the output video by performing an iteration of sub-steps 302-304 at each of a plurality of reverse diffusion steps. In other words, the final output video is generated after the last reverse diffusion step of the plurality of reverse diffusion steps.

The system processes, by a video diffusion model, a diffusion model input that includes (i) a current intermediate representation of the output video, (ii) the input text, (iii) the input video, and (iv) data identifying a time step (which corresponds to the current reverse diffusion step), to generate a noise output for the step (step 302). For example, the noise output can be an estimate of the noise that needs to be added to the output video to generate the current intermediate representation of the output video and that can be used to generate a prediction of the output video given the current intermediate representation. It will be understood that processing the current intermediate representation of the output video comprises processing pixels of one or more frames of the intermediate representation of the output video.

For example, the time steps can run in reverse from 1 to 0. For the first reverse diffusion step, the current intermediate representation is the initial intermediate representation of the output video that has been generated in step 206. For each subsequent reverse diffusion step, the current intermediate representation is the updated intermediate representation generated in the preceding reverse diffusion step.

The system uses the noise output to de-noise the current intermediate representation of the output video to generate an updated intermediate representation of the output video for the step (step 304). The system can update the current intermediate representation by applying a diffusion sampler to the current intermediate representation. Applying a diffusion sampler to the current intermediate representation results in an updated intermediate representation that has the same dimensionality as the current intermediate representation, but has different, i.e., updated, values.

For example, applying the diffusion sampler can include using a DDIM sampler with stochastic noise correction. At each step, the expected denoised image may be computed and used to estimate the noise. For example, a fraction of the estimated noise may be removed, and randomly generated Gaussian noise may be added, with magnitude corresponding to half of the removed noise. DDIM sampler is described in more detail in Jonathan Ho, et al. Imagen video: High definition video generation with diffusion models. arXiv preprint arXiv: 2210.02303, 2022. Other suitable samplers, e.g., ancestral samplers, can also be used.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow or JAX framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method of generating an output video, the method comprising:
obtaining an input video;
obtaining input text that includes a description of an output video;
generating, based at least on applying downsampling to the input video, a degraded version of the input video; and
generating the output video based on the description in the input text by updating the degraded version of the input video, wherein the updating comprises, at each of a plurality of steps:
processing, by a diffusion model, a diffusion model input comprising (i) a current intermediate representation of the output video and (ii) the input text to generate a noise output for the step; and
using the noise output to de-noise the current intermediate representation of the output video to generate an updated intermediate representation of the output video for the step.

2. The method of claim 1, wherein generating the degraded version of the input video comprises:
generating a downsampled version of the input video by applying downsampling to the input video; and
generating the degraded version of the input video by adding Gaussian noise with a predetermined variance to the downsampled version of the input video.

3. The method of claim 1, wherein obtaining the input video comprises:
receiving from a client device the input video that has a plurality of video frames.

4. The method of claim 1, wherein obtaining the input video comprises:
receiving from a client device one or more input images;
generating a synthetic video that has a plurality of video frames by replicating, transforming, or both each of the one or more input images; and
using the synthetic video as the input video.

5. The method of claim 1, wherein the diffusion model has pre-trained parameter values, and generating the output video based on the description in the input text comprises:
fine-tuning the diffusion model with respect to the input video to adjust the pre-trained parameter values of the diffusion model.

6. The method of claim 5, wherein fine-tuning the diffusion model with respect to the input video comprises:
adjusting the pre-trained parameter values of the diffusion model based on optimizing a mixed fine-tuning objective function that includes a first term that evaluates a difference between (i) the input video and (ii) a reconstructed representation of the input video generated by using the diffusion model, and a second term that evaluates a difference between (i) each of one or more frames of the input video and (ii) a reconstructed representation of each of the one or more frames of the input video generated by using the diffusion model.

7. The method of any one of claim 5, wherein fine-tuning the diffusion model with respect to the input video comprises:
generating a unique identifier for a subject instance depicted in the input video; and
processing the unique identifier as the input text by the diffusion model during the fine-tuning.

8. The method of any one of claim 5, wherein the diffusion model comprises (i) one or more temporal attention layers that each attend over the plurality of video frames in the input video when generating a corresponding attention layer output and (ii) one or more one or more spatial attention layers that each attend over a plurality of pixels in a video frame when generating a corresponding spatial attention layer output, and wherein fine-tuning the diffusion model on the input video comprises:
adjusting the pre-trained parameter values of the one or more spatial attention layers while holding the pre-trained parameter values of the one or more temporal attention layers fixed.

9. The method of any one of claim 1, wherein the output video and the input video both depict a subject instance but a motion, an appearance, or both of the subject instance are different.

10. A system comprising: one or more computers and one or more storage devices storing instructions that are operable, when executed by the one or more computers, to cause the one or more computers to perform operations comprising:
obtaining an input video;
obtaining input text that includes a description of an output video;
generating, based at least on applying downsampling to the input video, a degraded version of the input video; and
generating the output video based on the description in the input text by updating the degraded version of the input video, wherein the updating comprises, at each of a plurality of steps:
processing, by a diffusion model, a diffusion model input comprising (i) a current intermediate representation of the output video and (ii) the input text to generate a noise output for the step; and
using the noise output to de-noise the current intermediate representation of the output video to generate an updated intermediate representation of the output video for the step.

11. A computer storage medium encoded with a computer program, the program comprising instructions that are operable, when executed by data processing apparatus, to cause the data processing apparatus to perform operations comprising:
obtaining an input video;
obtaining input text that includes a description of an output video;
generating, based at least on applying downsampling to the input video, a degraded version of the input video; and
generating the output video based on the description in the input text by updating the degraded version of the input video, wherein the updating comprises, at each of a plurality of steps:
processing, by a diffusion model, a diffusion model input comprising (i) a current intermediate representation of the output video and (ii) the input text to generate a noise output for the step; and
using the noise output to de-noise the current intermediate representation of the output video to generate an updated intermediate representation of the output video for the step.

12. The system of claim 10, wherein:
the diffusion model has pre-trained parameter values, and generating the output video based on the description in the input text comprises fine-tuning the diffusion model with respect to the input video to adjust the pre-trained parameter values of the diffusion model; and
fine-tuning the diffusion model with respect to the input video comprises:
adjusting the pre-trained parameter values of the diffusion model based on optimizing a mixed fine-tuning objective function that includes a first term that evaluates a difference between (i) the input video and (ii) a reconstructed representation of the input video generated by using the diffusion model, and a second term that evaluates a difference between (i) each of one or more frames of the input video and (ii) a reconstructed representation of each of the one or more frames of the input video generated by using the diffusion model.

13. The system of claim 12, wherein fine-tuning the diffusion model with respect to the input video comprises:
generating a unique identifier for a subject instance depicted in the input video; and
processing the unique identifier as the input text by the diffusion model during the fine-tuning.

14. The system of claim 12, wherein the diffusion model comprises (i) one or more temporal attention layers that each attend over the plurality of video frames in the input video when generating a corresponding attention layer output and (ii) one or more one or more spatial attention layers that each attend over a plurality of pixels in a video frame when generating a corresponding spatial attention layer output, and wherein fine-tuning the diffusion model on the input video comprises:
adjusting the pre-trained parameter values of the one or more spatial attention layers while holding the pre-trained parameter values of the one or more temporal attention layers fixed.

15. The computer storage medium of claim 11, wherein:
the diffusion model has pre-trained parameter values, and generating the output video based on the description in the input text comprises fine-tuning the diffusion model with respect to the input video to adjust the pre-trained parameter values of the diffusion model; and
fine-tuning the diffusion model with respect to the input video comprises:
adjusting the pre-trained parameter values of the diffusion model based on optimizing a mixed fine-tuning objective function that includes a first term that evaluates a difference between (i) the input video and (ii) a reconstructed representation of the input video generated by using the diffusion model, and a second term that evaluates a difference between (i) each of one or more frames of the input video and (ii) a reconstructed representation of each of the one or more frames of the input video generated by using the diffusion model.

16. The computer storage medium of claim 15, wherein fine-tuning the diffusion model with respect to the input video comprises:
generating a unique identifier for a subject instance depicted in the input video; and
processing the unique identifier as the input text by the diffusion model during the fine-tuning.

17. The computer storage medium of claim 15, wherein the diffusion model comprises (i) one or more temporal attention layers that each attend over the plurality of video frames in the input video when generating a corresponding attention layer output and (ii) one or more one or more spatial attention layers that each attend over a plurality of pixels in a video frame when generating a corresponding spatial attention layer output, and wherein fine-tuning the diffusion model on the input video comprises:
adjusting the pre-trained parameter values of the one or more spatial attention layers while holding the pre-trained parameter values of the one or more temporal attention layers fixed.
